(19) United States
(12) Patent Application Publication
(10) Pub. No.: US 2008/0271613 A1
(43) Pub. Date: Nov. 6, 2008

(54) BBQ Grill Fire Guard

(76) Inventor: Daniel Lee, Everett, WA (US)

Correspondence Address: WILSON DANIEL SWAYZE, JR., 3804 CLEARWATER CT., PLANO, TX, 75025, US

(21) Appl. No.: 11/744,873

(22) Filed: May 6, 2007

(51) Int. Cl. A47J 37/07

(52) U.S. Cl. 99/446

(57) ABSTRACT

A BBQ grill apparatus for grilling food includes a grilling surface for grilling the food, a heat source for generating heat to grill the food, a protector member positioned over the heat source, a main body member positioned between the protector member and the grilling surface and adapted to contain a fluid to catch grease from the food. The protector member includes a first inclined surface and a second inclined surface. The main body member includes a first inclined floor member to cooperate with the first inclined surface and a second inclined floor member to cooperate with the second inclined surface. The main body member includes the upward projecting side member, a upward projecting end member and a foot member to maintain a spaced relationship between the protector member and the main body member.

### FIELD OF THE INVENTION

This invention relates generally to the field of outdoor cooking, and more particularly to an apparatus for improved containment of food drippings, and which prevents food drippings from escaping when smoking or grilling using electric, gas, or charcoal as the heat source.

### BACKGROUND

A known problem that occurs is that during grilling due to the openings present in the actual grill that holds the food fat drips into the heat source and burns with strong soot and smoke formation.

A known grill pan is (DE-GM 82 28 063.0) which includes a single-piece metal foil with an encircling flange and a grill surface formed by a number of grooves disposed at an essentially uniform distance from one another with beads between them. At both narrow sides of the grill pan, a collecting channel is provided and the two collecting channels are connected with one another by the two channels which are disposed adjoining the flange at the two long sides of the grill pan. Into the beads are worked recesses through which the radiation of the grill fire can impinge directly on the material to be grilled which is placed on the grill surface directly above the recesses.

In this known grill pan, the problem exists of endangering health as well as increasing the accumulation of waste and consequently increasing the load on the environment. From the meat heated by the radiation of the grill fire, the fat drips inter alia through the recesses in the beads into the grill fire and burns with the formation of a large quantity of soot. The problem is given of the formation of carcinogens endangering health. It is known that in the combustion of the dripping fat, in particular of benzene and its homologues the flame generating a large amount soot comprises as solid substances annellated aromatic hydrocarbons, among them 3,4-benzpyrene, which is known as a carcinogen and which together with the rising soot reaches the material to be grilled. Furthermore, the development of smoke and dense smoke increased during the combustion of fat is also a factor for an undesirable loading of the environment as well as the increased waste accumulated through the metal foil which must be discarded after the use of the grill pan.

Many prior art grill pans do not stop the flow of grease to the fire, and in the short amount of time, the grease can build to the point where the grease can catch fire and burn the meat. Additionally, a grease fire can potentially be a cause of a larger fire if not controlled.

### SUMMARY

The present invention provides an apparatus for trapping grease from food in a fluid to prevent the grease from reaching the heat source.

A BBQ grill apparatus for grilling food includes a grilling surface for grilling the food, a heat source for generating heat to grill the food, a protector member positioned over the heat source, a main body member positioned between the protector member and the grilling surface and adapted to contain a fluid to catch grease from the food.

The protector member includes a first inclined surface and a second inclined surface.

The main body member includes a first inclined floor member to cooperate with the first inclined surface and a second inclined floor member to cooperate with the second inclined surface.

The main body member includes the upward projecting side member, a upward projecting end member and a foot member to maintain a spaced relationship between the protector member and the main body member. The main body may include a substantially flat floor member, a handle and attachment apparatus. The attachment apparatus may be substantially L-shaped.

The heat source may be gas, charcoal or electric.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a perspective view of the grilling apparatus of the present invention with the main body member removed;

FIG. 2 illustrates a perspective view of the grilling apparatus of the present invention with the main body member attached;

FIG. 3 illustrates an end view of the grilling apparatus of the present invention;

FIG. 4 illustrates a perspective view of the main body member of the present invention;

FIG. 5 illustrates an end view of the main body member and feet member of the present invention;

FIG. 6 illustrates a side view of the main body member and feet member of the present invention;

FIG. 7 illustrates a top view of the main body member of the present invention;

FIG. 8 illustrates a partial perspective view of the main body member of the present invention;

FIG. 9 illustrates a perspective view of another embodiment of the grilling apparatus which a second main body member has been removed;

FIG. 10 illustrates a perspective view of the grilling apparatus of the present invention with the second main body member attached;

FIG. 11 illustrates an end view of the second main body member with an attachment apparatus;

FIG. 12 illustrates a sectional view of the attachment apparatus of the present invention;

FIG. 13 illustrates a perspective view of the second main body member of the present invention;

FIG. 14 illustrates an end view of the second main body member of the present invention;

FIG. 15 illustrates a side view of the second main body member of the present invention;

FIG. 16 illustrates a top view of the second main body member of the present invention;

FIG. 17 illustrates a perspective view of a portion of the second main body of the present invention.

### DETAILED DESCRIPTION

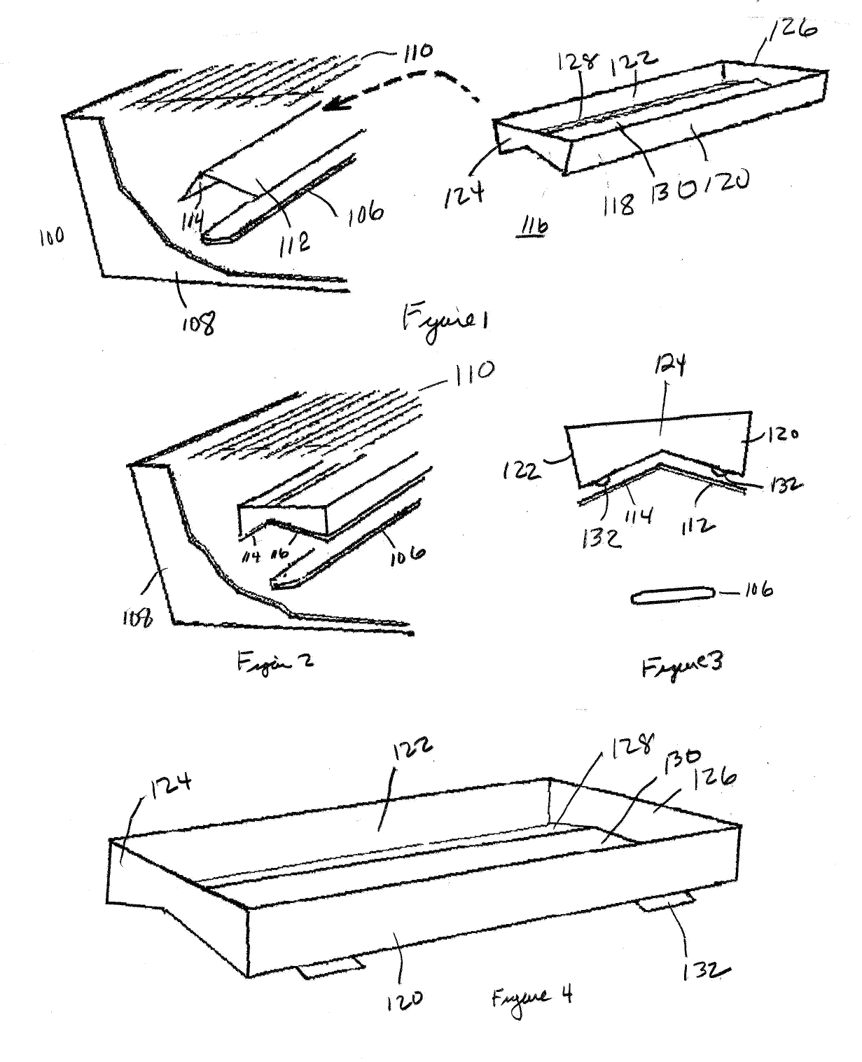

FIG. 1 illustrates a sectional view of a grill 100 in accordance with the teachings of the present invention. FIG. 1 illustrates a grill housing 108 which houses a gas burner 106 which may be formed from steel, stainless steel or any other suitable rigid material. FIG. 1 illustrates a gas burner 106, but the principles of the present invention are equally applicable to charcoal, wood, coal, electric or other source of heat. Generally, the gas burner 106 extends along the longitudinal direction of the grill housing 108, However, the gas burner 106 could extend along the traverse direction or any other suitable direction. FIG. 1 illustrates a gas burner protector member 102 which extends over the gas burner 106 and which is shown as having a first inclined surface 112 and a second inclined surface 114 which is formed at an angle. FIG. 1 additionally illustrates fire guard 116 which is formed to cooperate with the first inclined surface 112 and the second inclined surface 114. The fire guard 116 includes a main body member 118 which is a elongated member, and the main body member 118 includes upward projecting side members 120, 122 which extend from the inclined floor member 128, 130 and upward projecting end members 124, 126 which extends from the end of the inclined floor member 128, 130. FIG. 1 illustrates that the main body member 118 has been removed from the gas burner protector member 102. The main body member 118 is watertight so that water or other fluid may be added to the main body member 118 to catch the grease and prevent the grease from catching fire. The main body member 118 is positioned between the gas burner protector member 102 and the grilling surface 110.

FIG. 2 illustrates a perspective view of the assembled main body member 118 positioned directly on the gas burner protector member 102. The main body member 118 is detachably connected from the grill and more particularly the main body member 118 is detachably connected from the gas burner protector member 102.

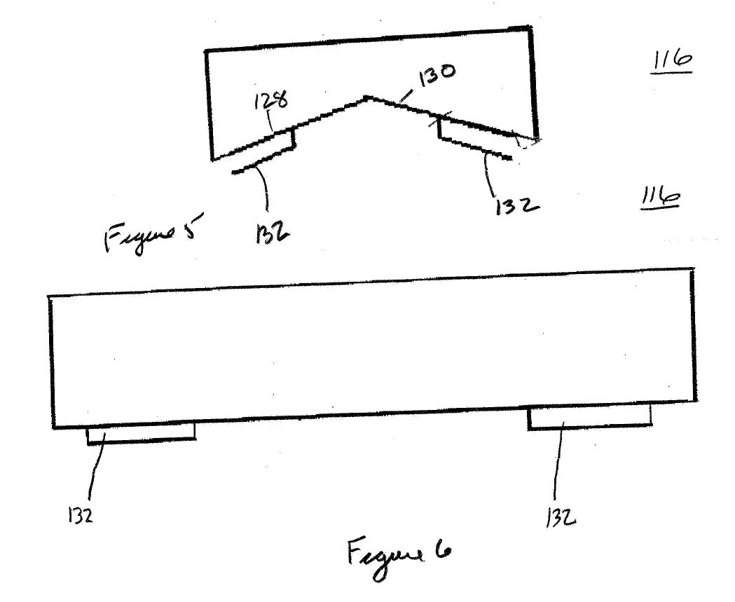

FIG. 3 illustrates an end view of the main body member 118 and illustrates the foot member 132 to maintain a spaced relationship between the first and second inclined surface 112, 114 and the first and second inclined floor member 128, 130.

FIG. 4 illustrates a perspective view of the main body member 118 and illustrates the first and second upward projecting side members 120, 122, the first and second upward projecting end members 124, 126 and the first and second inclined floor member 128, 130. FIG. 4 additionally illustrates the foot member 132.

FIG. 5 illustrates an end view of the main body member 118 and the foot member 132. FIG. 5 illustrates that a portion of the foot member 132 is substantially parallel to the first and second inclined floor member 128, 130 and the space between an foot member 132 and the first and second inclined floor member 128, 130 can be varied to reduce or increase the heat transfer from the gas burner protector member 120 and the main body member 118.

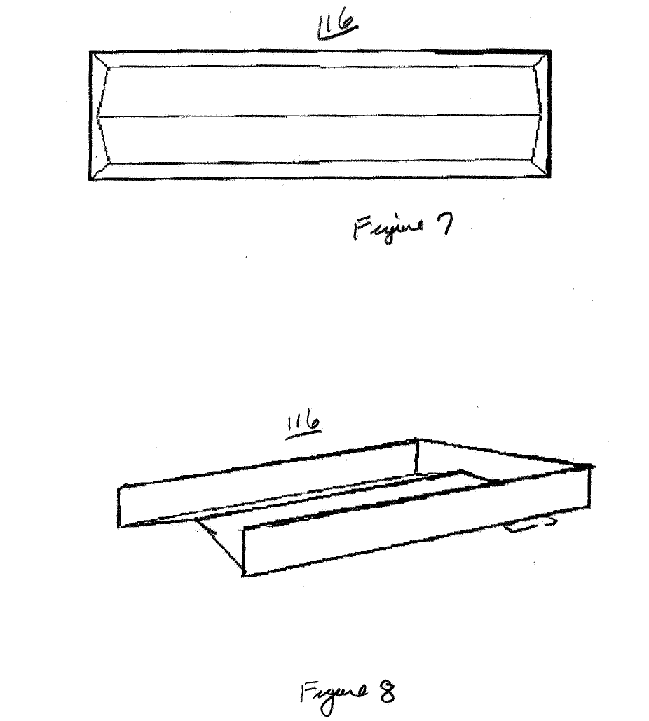

FIG. 6 illustrates a side view of the main body member 118 and shows the foot member 132.

FIG. 7 illustrates a top view of the main body member 118.

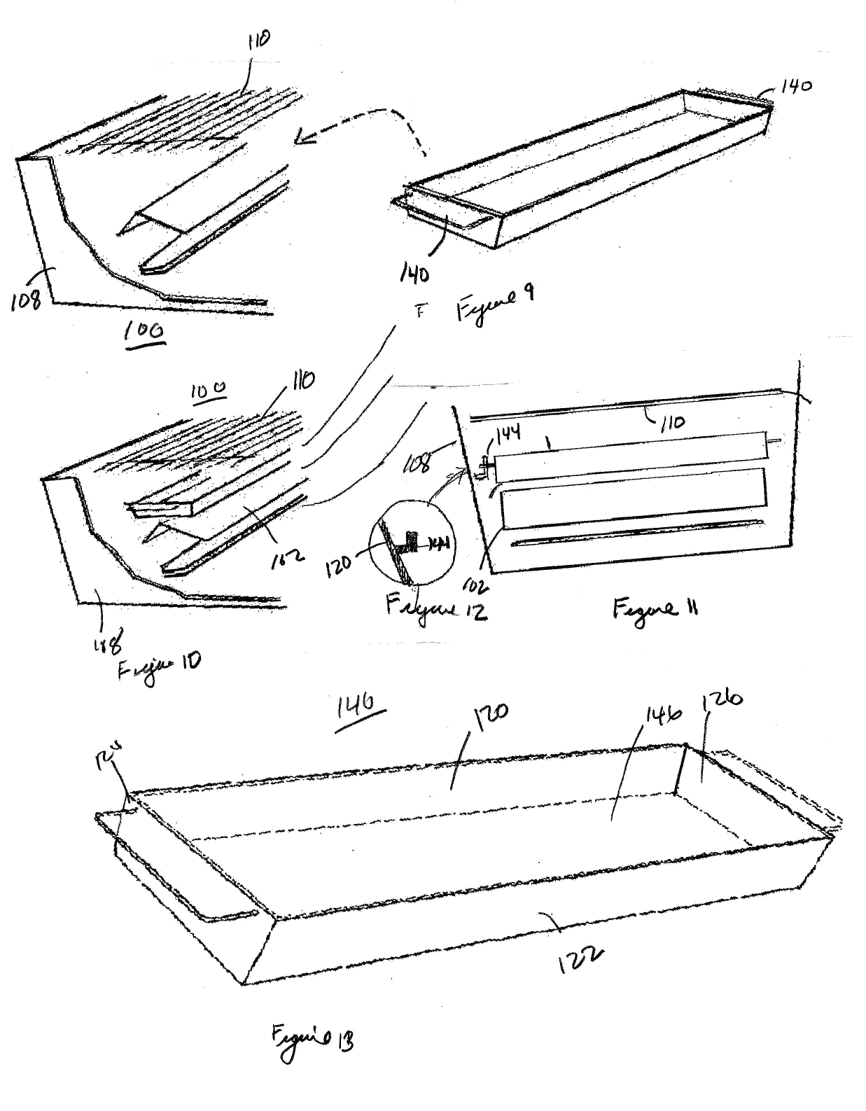

FIG. 8 illustrates a sectional view of the main body member 118. FIG. 9 illustrates another embodiment of the present invention and illustrates a second main body member 140 which includes handle member 142 positioned at opposing ends of the second main body member 140. FIG. 9 illustrates the second main body member 140 removed from the grill 100 while FIG. 10 illustrates the second main body member 140 positioned over the gas burner protector member 102 and under the grill surface 110. As a consequence, the second main body member 140 is detachably connected from the grill housing 108.

FIG. 11 illustrates an end view of the second main body member 140 position between the gas burner protector member 102 and the grill surface 110. FIG. 11 additionally illustrates an attachment apparatus 144 for attaching the second main body member 140 to the grill housing 108. The attachment apparatus 144 is substantially L-shaped to achieve a friction fit with the grill housing 108. The attachment apparatus 144 may be other shapes in accordance with the teaching of the present invention.

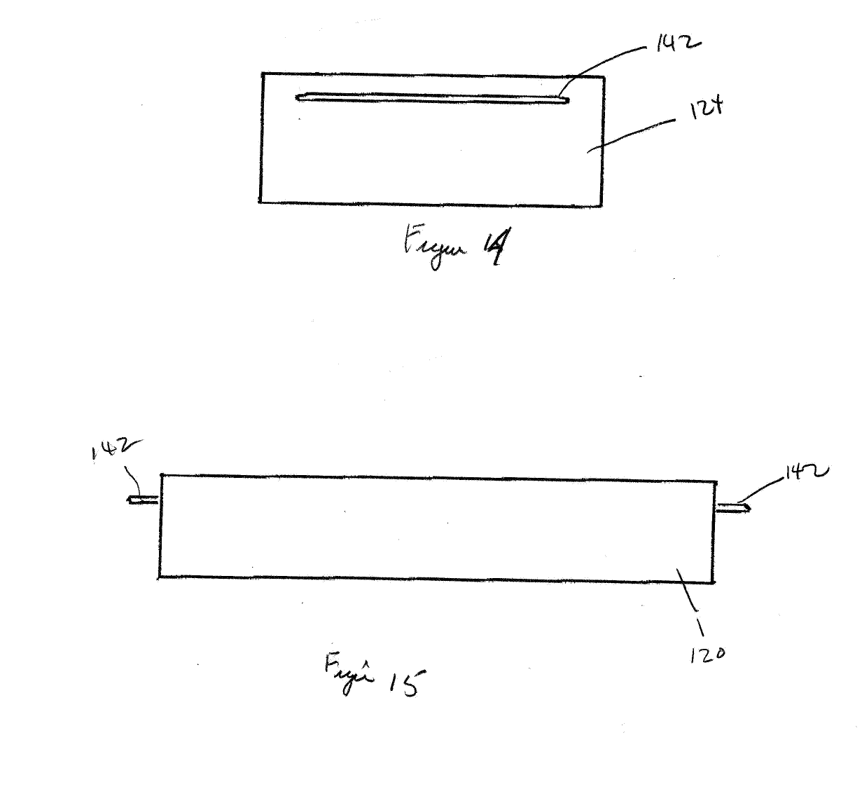

FIG. 12 illustrates a sectional view of the attachment apparatus 114 affixed to the upward projecting side member 120.

FIG. 13 illustrates the second main body member 140 in a perspective view which includes first and second upward projecting side members 120, 122, first and second upward projecting end member 124, 126 and a substantially flat floor member 146. The substantially flat floor member 146 is substantially flat in order that the second main body member 140 can retain more water or other fluid.

FIG. 14 illustrates an end view of the second main body member 140 including the handle member 142 and the upward projecting end member 124.

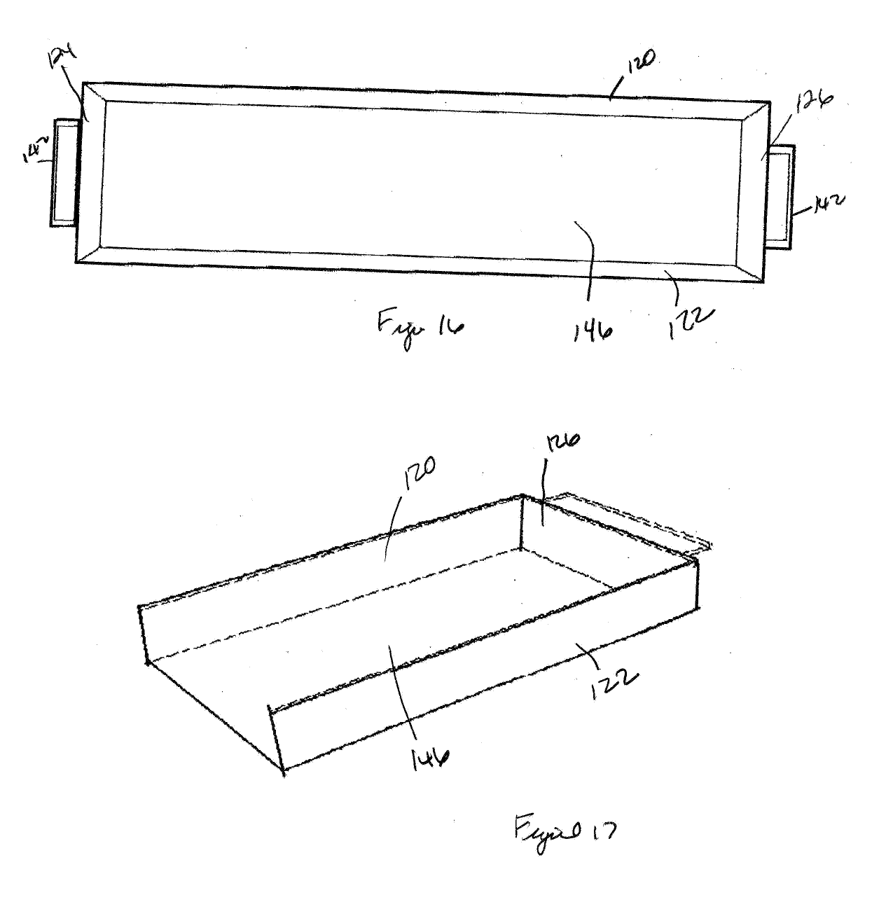

FIG. 15 illustrates a side view of the second main body member 140 including the handle member 142 and the upward projecting side member 120.

FIG. 16 illustrates a top view of the second main body member 140 which includes first and second upward projecting side members 120, 122, first and second upward projecting end members 124, 126, substantially flat floor member 146 and handle member of 142.

FIG. 17 illustrates a partial view of a portion of the second main body member 140 which includes first and second upward projecting side members 120, 122, first and second upward projecting end members 124, 126, substantially flat floor member 146 and handle member 142.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A BBQ grill apparatus for grilling food, comprising:
a grilling surface for grilling the food;
a heat source for generating heat to grill the food;
a protector member positioned over the heat source;
a main body member positioned between the protector member and the grilling surface and adapted to contain a fluid to catch grease from the food.

2) A BBQ grill apparatus for grilling food as in claim 1, wherein the protector member includes a first inclined surface.

3) A BBQ grill apparatus for grilling food as in claim 2, wherein the protector member includes a second inclined surface.

4) A BBQ grill apparatus for grilling food as in claim 2, wherein the main body member includes a first inclined floor member to cooperate with the first inclined surface.

5) A BBQ grill apparatus for grilling food as in claim 3, wherein the main body member includes a second inclined floor member to cooperate with the second inclined surface.

6) A BBQ grill apparatus for grilling food as in claim 1, wherein the main body member includes the upward projecting side member.

7) A BBQ grill apparatus for grilling food as in claim 1, wherein the main body member includes a upward projecting end member.

8) A BBQ grill apparatus for grilling food as in claim 1, wherein the main body includes a foot member to maintain a spaced relationship between the protector member and the main body member.

9) A BBQ grill apparatus for grilling food as in claim 1, wherein the main body includes a substantially flat floor member.

10) A BBQ grill apparatus for grilling food as in claim 1, wherein the main body includes a handle.

11) A BBQ grill apparatus for grilling food as in claim 1, wherein the main body includes an attachment apparatus.

12) A BBQ grill apparatus for grilling food as in claim 11, wherein the attachment apparatus is substantially L-shaped.

13) A BBQ grill apparatus for grilling food as in claim 1, wherein the heat source is gas.

14) A BBQ grill apparatus for grilling food as in claim 1, wherein the heat source is charcoal.

15) A BBQ grill apparatus for grilling food as in claim 1, wherein the heat source is electric.
